(19) United States
(12) Patent Application Publication
(10) Pub. No.: US 2012/0092441 A1
(43) Pub. Date: Apr. 19, 2012

(54) SYSTEM AND METHOD FOR PROVIDING A PARING MECHANISM IN A VIDEO ENVIRONMENT

(75) Inventors: Gangfeng Kong, San Jose, CA (US); David J. Mackle, San Jose, CA (US)

(73) Assignee: Cisco Technology, Inc.

(21) Appl. No.: 12/907,927

(22) Filed: Oct. 19, 2010

(51) Int. Cl. H04N 7/14

(52) U.S. Cl. 348/14.08; 348/E07.077

(57) ABSTRACT

A method is provided in one example and includes identifying an event associated with a universal serial bus (USB) connection, and establishing an Ethernet channel. The method also includes discovering a handset associated with a videoconferencing platform, and verifying an authentication message from the handset. A service set identifier (SSID) and a password can be created and communicated to the handset through the Ethernet channel. The SSID and the password are used to associate the handset with a console element configured to control operations associated with the videoconferencing platform.

### TECHNICAL FIELD

This disclosure relates in general to the field of communications and, more particularly, to providing a pairing mechanism in a video environment.

### BACKGROUND

Video services have become increasingly important in today's society. In certain architectures, service providers may seek to offer sophisticated videoconferencing services for their end users. The videoconferencing architecture can offer an “in-person” meeting experience over a network. Videoconferencing architectures can deliver real-time, face-to-face interactions between people using advanced visual, audio, and collaboration technologies. The ability to optimize video communications provides a significant challenge to system designers, device manufacturers, and service providers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system for providing a video session in a network environment in accordance with one embodiment of the present disclosure;

FIG. 2 is a simplified block diagram illustrating one example implementation of certain components associated with the system;

FIG. 3 is a simplified block diagram illustrating one example implementation of network traffic management associated with the system;

FIGS. 4A-4B are simplified flow diagrams illustrating example operations associated with the system; and

FIG. 5 is a simplified block diagram illustrating one example implementation relating to a handset and a console element associated with the system.

### DETAILED DESCRIPTION OF EXAMPLE EMBODIMENTS

### Overview

A method is provided in one example and includes identifying an event associated with a universal serial bus (USB) connection, and establishing an Ethernet channel. The method also includes discovering a handset associated with a videoconferencing platform, and verifying an authentication message from the handset. A service set identifier (SSID) and a password can be created and communicated to the handset through the Ethernet channel. The SSID and the password are used to associate the handset with a console element configured to control operations associated with the videoconferencing platform.

In more particular embodiments, a link layer discovery protocol (LLDP) is used for discovering the handset associated with the videoconferencing platform. Additionally, the event can be associated with a USB cable being connected to the handset and the console element. The connection enables an Ethernet-over-USB capability on the handset and the console element. The authentication message can be based on a security mechanism (e.g., a cryptographic scheme, a hash function, etc.) shared by the handset and the console element. The verifying can include identifying a match associated with the particular authentication message. A WiFi link can be configured to be used for an association activity between the handset and the console element.

### EXAMPLE EMBODIMENTS

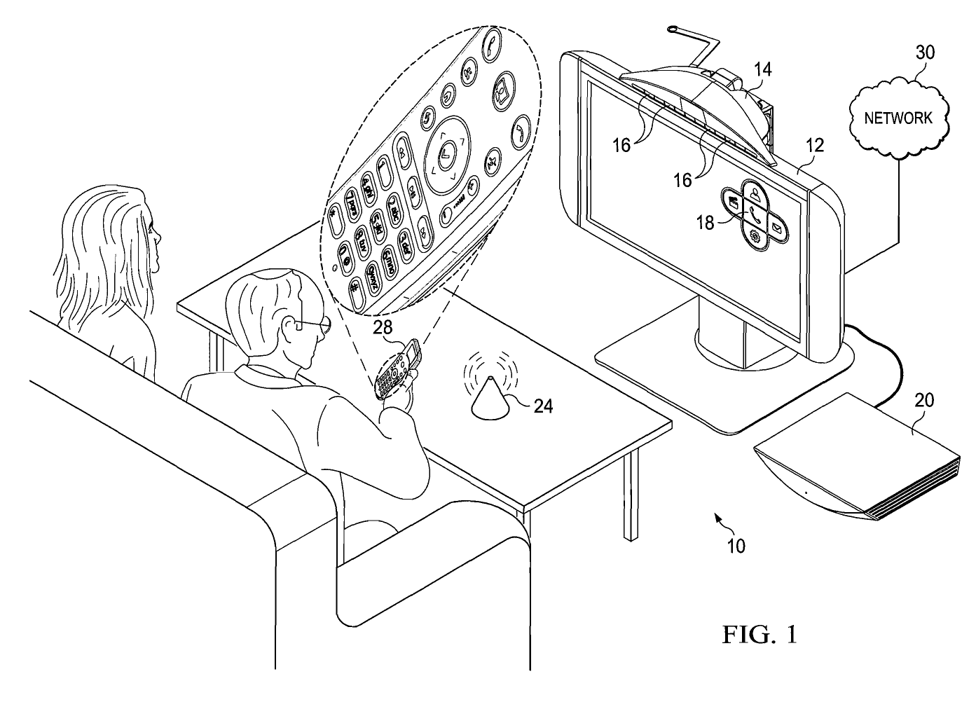

Turning to FIG. 1, FIG. 1 is a simplified block diagram of a system 10 for providing a video session in a network environment. In this particular example, system 10 may include a display 12, a camera element 14, a user interface (UI) 18, a console element 20, a handset 28, and a network 30. A series of speakers 16 are provisioned in conjunction with camera element 14 in order to transmit and receive audio data. In one particular example implementation, a wireless microphone 24 is provided in order to receive audio data in a surrounding environment (e.g., from one or more audience members). Note that this wireless microphone 24 is purely optional, as speakers 16 are capable of sufficiently capturing audio data in a surrounding environment during any number of videoconferencing applications (which are detailed below).

In general terms, system 10 can be configured to capture video image data and/or audio data in the context of videoconferencing. System 10 may include a configuration capable of transmission control protocol/internet protocol (TCP/IP) communications for the transmission and/or reception of packets in a network. System 10 may also operate in conjunction with a user datagram protocol/IP (UDP/IP) or any other suitable protocol, where appropriate and based on particular communication needs.

In certain implementations, handset 28 can be used as a remote control for system 10. For example, handset 28 can offer a wireless remote control that allows it to communicate with display 12, camera element 14, and/or console element 20 via a wireless network link (e.g., infrared, Bluetooth, any type of IEEE 802.11-based protocol, etc.). Handset 28 can further be provisioned as a wireless mobile phone (e.g., a speakerphone device) with various dial pads: some of which are shown by way of example in FIG. 1. In a particular example, handset 28 can include its own user interface (e.g., a small window, surface, or display as shown in FIG. 1) to render images, messages, and/or data to a given end user. For example, the interface can offer messages to prompt the user to complete certain actions, to initiate certain updates, to notify the user of new videomail, etc.

In other implementations, handset 28 operates as a learning mechanism and/or a universal remote controller, which allows it to readily control display 12, camera element 14, console element 20, and/or any audiovisual (AV) receiver device (e.g., managing functions such as ON/OFF, volume, input select, etc. to enhance the overall video experience). In a particular set of examples, a specific button on handset 28 can launch UI 18 for navigating through any number of options provided in submenus of the UI software. Additionally, a dedicated button can be used to make/answer calls, end calls, turn on/off camera element 14, turn on/off the microphone on, turn on/off console element 20, etc. Furthermore, a set of playback controls can be provided on handset 28 in order to control the video data being rendered on display 12.

Note that handset 28 can be configured to launch, control, and/or manage UI 18. In one particular instance, UI 18 includes a clover design having four separate functions along its perimeter (i.e., up, down, left, right). The center of UI 18 can be used to initiate calls or to configure call options. The lower widget icon may be used to adjust settings, inclusive of controlling profile information, privacy settings, console settings, etc. The right-hand icon (when selected) can be used to view video messages sent to a particular user. The upper icon can be used to manage contacts (e.g., add, view, and connect to other individuals). The director's card (provided as the left icon) can be used to record and send video messages to other individuals. It is imperative to note that these menu choices can be changed considerably without departing from the scope of the present disclosure. Additionally, these icons may be customized, changed, or managed in any suitable fashion. Furthermore, the icons of UI 18 are not exhaustive, as any other suitable features may be provided in the context of UI 18. Along similar lines, the submenu navigation choices provided beneath each of these icons can include any suitable parameter applicable to videoconferencing, networking, user data management, profiles, etc.

In operation of an example implementation, system 10 can be used to conduct video calls (e.g., supporting both inbound and outbound directional call flows). For the inbound call scenario, on reception of an inbound call request, console element 20 is configured to contact the paired handset(s) 28 (e.g., waking it from sleep, where appropriate). Handset 28 can be configured to play a ringtone, turn on an LED indicator, and/or display UI 18 (e.g., including the incoming caller's contact information). If configured to do so, UI 18 can also be displayed over any passthrough video sources on console element 20. If the callee chooses to answer the call with one of the call control buttons, console element 20 offers its media capabilities to the caller's endpoint. In certain example implementations, by default, audio media can be offered at the start of the call. At any time during a voice call, both parties can agree to enter into a full video session (e.g., referred to as a “go big” protocol) at which point video media is negotiated. As a shortcut, the intention to “go big” can be pre-voted at the start of the call. At any time after video media is flowing, the call can also be de-escalated back to an audio-only call. In certain instances, there could be an option to automatically answer incoming calls as immediate full-video sessions.

In the case of an ad hoc outbound call, the user can select a callee from their contact list, select a callee via a speed dial setting, or alternatively the user can enter any type of identifier (e.g., a telephone number, a name, a videoconferencing (e.g., Telepresence, manufactured by Cisco, Inc. of San Jose, Calif.) number directly). If the callee answers, the call scenario proceeds, similar to that of an inbound call. In the case of a hold and resume scenario, an in-call UI 18 signal can be provided to put a call on hold, and subsequently the call can be resumed at a later time. Note that in other instances, system 10 can be used to execute scheduled calls, call transfer functions, multipoint calls, and/or various other conferencing capabilities.

In the case of the consumer user attempting a communication with a business entity, certain parameters may be changed based on interoperability issues. For example, secure business endpoints may be supported, where signaling and media would be secure (both audio and video). Appropriate messages can be displayed in UI 18 to inform the user of the reason for any security-forced call drops. Signaling can be considered secure by having both a business exchange and consumer networks physically co-located, or by using a secure tunnel (e.g., a site-to-site virtual private network (VPN) tunnel) between the two entities.

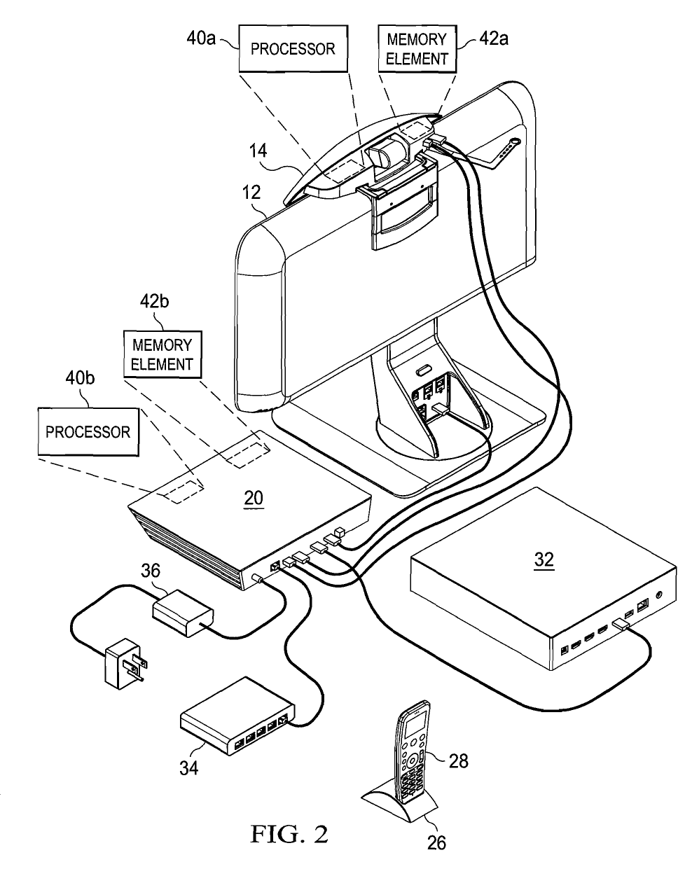

Before turning to additional flows associated with system 10, FIG. 2 is introduced in order to illustrate some of the potential arrangements and configurations for system 10. In the particular example implementation of FIG. 2, camera element 14 includes a processor 40a and a memory element 42a. Camera element 14 is coupled to console element 20, which similarly includes a processor 40b and a memory element 42b. A power cord 36 is provided between an outlet and console element 20. Any suitable connections (wired or wireless) can be used in order to connect any of the components of FIG. 2. In certain examples, the cables used may include Ethernet cables, High-Definition Multimedia Interface (HDMI) cables, universal serial bus (USB) cables, or any other suitable link configured for carrying data or energy between two devices.

In regards to a physical infrastructure, camera element 14 can be configured to fasten to any edge (e.g., a top edge) of display 12 (e.g., a flat-screen HD television). Camera element 14 can be included as part of an integrated component (i.e., a single component, a proprietary element, a set-top box, console element 20, etc.) that could include speakers 16 (e.g., an array microphone). Thus, all of these elements (camera element 14, speakers 16, console element 20) can be combined and/or be suitably consolidated into an integrated component that rests on (or that is fixed to, or that is positioned near) display 12. Alternatively, each of these elements are their own separate devices that can be coupled (or simply interact with each other), or be adequately positioned in any appropriate fashion.

Also provided in FIG. 2 are a router 34 and a set-top box 32: both of which may be coupled to console element 20. In a particular example, router 34 can be a home wireless router configured for providing a connection to network 30. Alternatively, router 34 can employ a simple Ethernet cable in order to provide network connectivity for data transmissions associated with system 10. Handset 28 can be recharged through a cradle dock 26 (as depicted in FIG. 2). [Handset 28 can be functional while docked.] Alternatively, handset 28 may be powered by batteries, solar charging, a cable, or by any power source, or any suitable combination of these mechanisms.

In one particular example, the call signaling of system 10 can be provided by a session initiation protocol (SIP). In addition, the media for the videoconferencing platform can be provided by Secure Real-time Transport Protocol (SRTP), or any other appropriate real-time protocol. SRTP addresses security for RTP and, further, can be configured to add confidentiality, message authentication, and replay protection to that protocol. SRTP is preferred for protecting voice over IP (VoIP) traffic because it can be used in conjunction with header compression and, further, it generally has no effect on IP quality of service (QoS). For network address translation (NAT)/firewall (FW) traversal, any suitable mechanism can be employed by system 10. In one particular example, these functions can be provided by a split-tunneled VPN with session traversal utilities for NAT (STUN) and Interactive Connectivity Establishment (ICE).

Signaling can propagate to a call agent via the VPN. Additionally, media can be sent directly from the endpoint to another endpoint (i.e., from one videoconferencing platform to another). Note that as used herein, the term ‘media’ is inclusive of audio data (which may include voice data) and video data (which may include any type of image data). The video data can include any suitable images (such as that which is captured by camera element 14, by a counterparty's camera element, by a Webcam, by a smartphone, by an iPad, etc.). The term ‘smartphone’ as used herein includes any type of mobile device capable of operating in conjunction with a video service. This would naturally include items such as the Google Droid, the iPhone, an iPad, etc. In addition, the term ‘signaling data’ is inclusive of any appropriate control information that can be sent toward a network. This may be inclusive of traffic used to establish a video session initially, along with any type of negotiations (e.g., for bit rates, for bandwidth, etc.) that may be appropriate for the particular videoconference. This may further be inclusive of items such as administrative traffic, account traffic (for user account management, contact lists [which include buddy lists, as detailed below], etc.), and/or other types of traffic, which are not provided as part of the media data.

In order to handle symmetric NAT, Traversal Using Relay NAT (TURN) can be used by system 10 in particular embodiments. User names for the videoconferencing platform can be provided by E.164 numbers in a particular example. Alternatively, the user naming can be a simple user ID (e.g., assigned by the service provider, selected by the user, etc.), a full name of the user (or a group name), an avatar, or any other symbol, number, or letter combination that can be used to distinguish one user from another. Note that a single name can also be associated with a group (e.g., a family, a business unit, etc.). The security for communications of system 10 can be addressed a number of ways. In one implementation, the video services (i.e., cloud services) can be protected by any suitable security protocol (e.g., security software, adaptive security appliances (ASA), etc.). Additionally, intrusion protection systems, firewalls, anti-denial of service mechanisms can be provided for the architecture (both out in the network, and/or locally within a residential environment).

Turning to details associated with the infrastructure of system 10, in one particular example, camera element 14 is a video camera configured to capture, record, maintain, cache, receive, and/or transmit image data. This could include transmitting packets over network 30 to a suitable next destination. The captured/recorded image data could be stored in camera element 14 itself, or be provided in some suitable storage area (e.g., a database, a server, console element 20, etc.). In one particular instance, camera element 14 can be its own separate network device and have a separate IP address. Camera element 14 could include a wireless camera, a high-definition camera, or any other suitable camera device configured to capture image data.

Camera element 14 may interact with (or be inclusive of) devices used to initiate a communication for a video session, such as a switch, console element 20, a proprietary endpoint, a microphone, a dial pad, a bridge, a telephone, a computer, or any other device, component, element, or object capable of initiating video, voice, audio, media, or data exchanges within system 10. Camera element 14 can also be configured to include a receiving module, a transmitting module, a processor, a memory, a network interface, a call initiation and acceptance facility such as a dial pad, one or more displays, etc. Any one or more of these items may be consolidated, combined, eliminated entirely, or varied considerably and those modifications may be made based on particular communication needs.

Camera element 14 can include a high-performance lens and an optical zoom, where camera element 14 is capable of performing panning and tilting operations. The video and the audio streams can be sent from camera element 14 to console element 20, where they are mixed into the HDMI stream. In certain implementations, camera element 14 can be provisioned as a light sensor such that the architecture can detect whether the shutter of the camera is open or closed (or whether the shutter is partially open.) An application program interface (API) can be used to control the operations of camera element 14.

Display 12 offers a screen at which video data can be rendered for the end user. Note that as used herein in this Specification, the term ‘display’ is meant to connote any element that is capable of delivering image data (inclusive of video information), text, sound, audiovisual data, etc. to an end user. This would necessarily be inclusive of any panel, plasma element, television (which may be high-definition), monitor, computer interface, screen, Telepresence devices (inclusive of Telepresence boards, panels, screens, surfaces, etc.) or any other suitable element that is capable of delivering/rendering/projecting such information.

Network 30 represents a series of points or nodes of interconnected communication paths for receiving and transmitting packets of information that propagate through system 10. Network 30 offers a communicative interface between any of the components of FIGS. 1-2 and remote sites, and may be any local area network (LAN), wireless local area network (WLAN), metropolitan area network (MAN), wide area network (WAN), VPN, Intranet, Extranet, or any other appropriate architecture or system that facilitates communications in a network environment.

Console element 20 is configured to receive information from camera element 14 (e.g., via some connection that may attach to an integrated device (e.g., a set-top box, a proprietary box, etc.) that sits atop (or near) display 12 and that includes (or is part of) camera element 14). Console element 20 may also be configured to control compression activities, or additional processing associated with data received from camera element 14. Alternatively, the actual integrated device can perform this additional processing before image data is sent to its next intended destination. Console element 20 can also be configured to store, aggregate, process, export, or otherwise maintain image data and logs in any appropriate format, where these activities can involve processor 40b and memory element 42b. Console element 20 is a video element that facilitates data flows between endpoints and a given network. As used herein in this Specification, the term ‘video element’ is meant to encompass servers, proprietary boxes, network appliances, set-top boxes, or other suitable device, component, element, or object operable to exchange video information with camera element 14.

Console element 20 may interface with camera element 14 through a wireless connection, or via one or more cables or wires that allow for the propagation of signals between these elements. These devices can also receive signals from an intermediary device, a remote control, handset 28, etc. and the signals may leverage infrared, Bluetooth, WiFi, electromagnetic waves generally, or any other suitable transmission protocol for communicating data (e.g., potentially over a network) from one element to another. Virtually any control path can be leveraged in order to deliver information between console element 20 and camera element 14. Transmissions between these two devices can be bidirectional in certain embodiments such that the devices can interact with each other. This would allow the devices to acknowledge transmissions from each other and offer feedback where appropriate. Any of these devices can be consolidated with each other, or operate independently based on particular configuration needs. In one particular instance, camera element 14 is intelligently powered using a USB cable. In a more specific example, video data is transmitted over an HDMI link, and control data is communicated over a USB link.

In certain examples, console element 20 can have an independent light sensor provisioned within it to measure the lighting in a given room. Subsequently, the architecture can adjust camera exposure, shuttering, lens adjustments, etc. based on the light that is detected in the room. Camera element 14 is also attempting to provide this function; however, having a separate light sensor offers a more deterministic way of adjusting these parameters based on the light that is sensed in the room. An algorithm (e.g., within camera element 14 and/or console element 20) can be executed to make camera adjustments based on light detection. In an IDLE mode, the lens of camera element 14 can close automatically. The lens of camera element 14 can open for an incoming call, and can close when the call is completed (or these operations may be controlled by handset 28). The architecture can also account for challenging lighting environments for camera element 14. For example, in the case of bright sunlight behind an individual, system 10 can optimize the exposure of the individual's face.

In regards to audio data (inclusive of voice data), in one particular example, speakers 16 are provisioned as a microphone array, which can be suitably calibrated. Note that in certain consumer applications, the consumer's home system is the variant, which is in contrast to most enterprise systems that have fixed (predictable) office structures. Camera element 14 can include an array of eight microphones in a particular example, but alternatively any number of microphones can be provisioned to suitably capture audio data. The microphones can be spaced linearly, or logarithmically in order to achieve a desired audio capture function. A MicroElectrical-Mechanical System (MEMS) technology can be employed for each microphone in certain implementations. The MEMS microphones represent variations of the condenser microphone design, having a built in analog-to-digital converter (ADC) circuits.

The audio mechanisms of system 10 can be configured to add a delay to the system in order to ensure that the acoustics function properly. In essence, the videoconferencing architecture does not inherently know the appropriate delay because of the unique domain of the consumer. For example, there could be a home theater system being used for acoustic purposes. Hence, system 10 can determine the proper delay, which would be unique to that particular environment. In one particular instance, the delay can be measured, where the echoing effects from the existing speakers are suitably canceled. An embedded watermarking signature can also be provided in each of the speakers, where the signature can be detected in order to determine an appropriate delay. Note that there is also some additional delay added by display 12 itself because the clocking mechanism is generally not deterministic. The architecture can dynamically update the delay to account for this issue. Many of these functions can be accomplished by console element 20 and/or camera element 14: both of which can be intelligently configured for performing these function adjustments.

The architecture can also send out a signal (e.g., white noise) as a test for measuring delay. In certain instances, this function is done automatically without having to prompt the user. The architecture can also employ wireless microphone 24, which can use a dedicated link in certain implementations. Wireless microphone 24 can be paired (akin to Bluetooth pairing) such that privacy issues can be suitably addressed. Wireless microphone 24 can be taken anywhere (i.e., in the room, in the house, etc.) and still provide appropriate audio functions, where multiplexing would occur at console element 20 for this particular application. Similarly, there could be an incarnation of the same for a given speaker (or the speaker/microphone can be provided together as mobile units, which are portable). The speaker could be similarly used anywhere in the room, in the house, etc. It should be noted that this is not only a convenience issue, but also a performance issue in suitably capturing/delivering audio signals having the proper strength and quality.

In terms of call answering and video messaging, handset 28 allows an individual to have the option of taking a voice call instead of answering a videoconferencing call. This is because handset 28 can have the intelligence to operate purely as a mobile phone. For this reason, handset 28 can readily be substituted/replaced by various types of smartphones, which could have an application provisioned thereon for controlling the videoconferencing activities. Handset 28 also affords the ability to be notified (through the handset itself) of an incoming videoconferencing call, with the option of rendering that call on display 12. A simple visual alert (e.g., an LED, a vibration, etc.) can be used to indicate a video message is waiting to be heard/watched. Video messages can be retrieved by any suitable endpoint (e.g., through the videoconferencing platform itself, through a laptop, through a smartphone, etc.).

The video messaging can include snapshots of video frames that would be indicative of the actual message images. In the user's video Inbox, the current videomail can include images of the actual messages being stored for future playback. For example, if the message were from the user's mother, the videomail would include a series of snapshots of the mother speaking during that videomail. In one particular example, the actual videomail is sampled at certain time intervals (e.g., every 10 seconds) in order to generate these images, which serve as a preview of the videomail message. Alternatively, the snapshots can be limited in number. In other instances, the snapshots are arbitrarily chosen, or selected at the beginning, the middle, and the end of the video message. In other implementations, the snapshots are taken as a percentage of the entire video message (e.g., at the 20% mark, at the 40% mark, and at the 100% mark). In other examples, the videomail in the Inbox is previewed by just showing the image associated with that particular user ID that authored the video message.

In operation of an example involving a user watching a normal television program on display 12, an incoming call can be received by the videoconferencing platform. The notification can arrive even if the television is off (e.g., through speakers of system 10). If an individual chooses to answer the call, then the videoconferencing platform takes over the television. In one example involving a digital video recorder (DVR), the programming can be paused. In other examples, the user can keep the call minimized so (for example) a user could speak with a friend while watching a football game. Console element 20 can be configured to record a message, and then send that message to any suitable next destination. For example, the user can send a link to someone for a particular message. The user can also use Flip Share or YouTube technology to upload/send a message to any appropriate destination. In a general sense, the messages can be resident in a network cloud such that they could still be accessed (e.g., over a wireless link) even if the power were down at the residence, or if the user were not at the residence.

The user can also switch from a video call to handset 28, and from handset 28 back to a video call. For example, the user can initiate a call on a smartphone and subsequently transition it to the videoconferencing display 12. The user can also do the reverse, where the user starts at the videoconferencing platform and switches to a smartphone. Note that wireless microphone 24 can operate in a certain, preferred range (e.g., 12 to 15 feet), where if the individual moves further away from that range, users could elect to transition to handset 28 (in a more conventional telephony manner). Consider the case where the room becomes noisy due to family members, and the user on the videoconferencing call elects to simply switch over to a smartphone, to a given landline, etc.

Motion detection can also be used in order to initiate, or to answer video calls. For example, in the case where a remote control is difficult to find in a living room, a simple hand-waving gesture could be used to answer an incoming video call. Additionally, the system (e.g., camera element 14 cooperating with console element 20) can generally detect particular body parts in order to execute this protocol. For example, the architecture can distinguish between a dog running past display 12, versus handwaving being used to answer an incoming call. Along similar lines, the user can use different gestures to perform different call functions (e.g., clasping his hands to put a call on hold, clapping his hands to end the call, pointing in order to add a person to a contact list, etc.).

Note that Wi-Fi is fully supported by system 10. In most videoconferencing scenarios, there can be massive amounts of data (much of which is time critical) propagating into (or out of) the architecture. Video packets (i.e., low-latency data) propagating over a Wi-Fi connection can be properly accommodated by system 10. In one particular example, nonmoving (static) background images can be segmented out of the video image, which is being rendered by display 12. The architecture (e.g., through console element 20) can then lower the bit rate significantly on those images. Allocations can then be made for other images that are moving (i.e., changing in some way). In certain example implementations, face-detection algorithms can also be employed, where the video is optimized based on those algorithm results.

Certain phone features allow for handset 28 to offer speed dialing, and a mechanism for saving contacts into a contact list. Calls can be made to users on the speed dial list or the contact list with a single button push on handset 28. Additionally, calls can be initiated using either the UI of handset 28, or the on-screen UI 18. Furthermore, calls can be initiated from a web portal, where the caller can confirm call initiation at the endpoint by pressing voice-only, or a video call button on handset 28. Also, calls can be initiated from other web pages via a call widget (e.g., calling a person by clicking on his Facebook object). In addition, the caller can look up a recipient in an online directory (e.g., a directory of all Telepresence users stored in a database), place a call to that recipient, and save the recipient's contact information into the contact list. In terms of receiving videoconferencing calls, incoming calls can be accepted with a single button push on handset 28. Call recipients have the opportunity to accept or reject a call. Rejected calls can be routed to videomail (if permitted by the recipient's safety settings).

In regards to call quality, if the available bandwidth decreases during a call, the video resolution is scaled down, as appropriate. If the available bandwidth increases during a call, the video resolution can be scaled up. An on-screen icon can be provided on display 12 to inform the user of the quality of his videoconferencing experience. The purpose of this information can be to inform the user of a poor experience, potentially being caused by network conditions, and that the user can improve his experience by upgrading his broadband service. When communicating with a Webcam, the picture on display 12 can be windowed inside a black frame: regardless of the actual quality of the Webcam video.

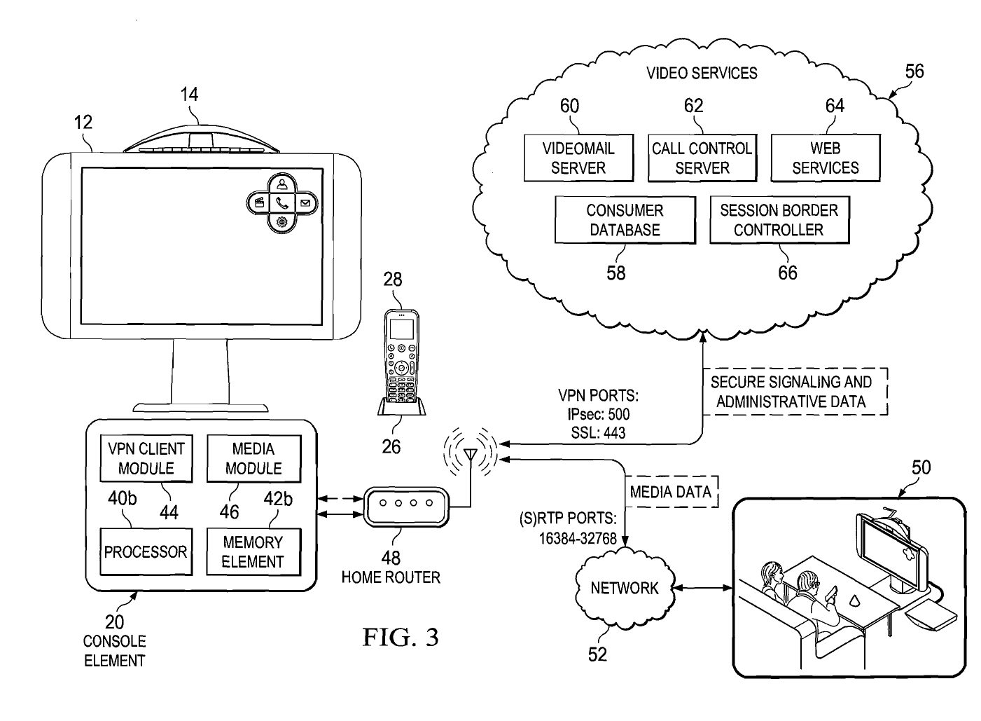

In regards to videomail, when a call cannot be answered in real time, it is not lost, but rather, forwarded automatically to videomail. Videomail can be accessed from the videoconferencing system, the web portal, a smartphone, laptop, etc. Videomail can be stored in the network (e.g., in the cloud) in particular implementations of system 10. Alternatively, the videomail can be stored locally at the consumer's residence (e.g., at a laptop, a personal computer, an external hard drive, a server, or in any other appropriate data storage device). Videomail can be played with the following minimum set of playback controls: Play, Pause, Stop, Fast or Skip Forward, Fast or Skip Reverse, Go Back to Start. In a particular implementation, videomail is only viewed by the intended recipient. Notifications of new videomail can be sent to other devices by short message service (SMS) text message (e.g., to a mobile device) or by email. An immediate notification can also be shown on handset 28. For video recordings, videos can be recorded and stored in the network for future viewing and distribution (e.g., as part of video services, which are detailed below with reference FIG. 3). Calls can similarly be recorded in real time and stored in the network for future viewing and distribution. When sharing recorded videos with videoconferencing users, the architecture can specify exactly which videoconferencing users have access to the video data. When the share list contains one or more email addresses, access control is not enabled in particular implementations (e.g., any individual who has the URL could access the video).

In terms of media sharing, system 10 can provide a simple mechanism for sharing digital photos and videos with removable flash media, flash and hard-drive high definition digital camcorders, digital still cameras, and other portable storage devices. This can be fostered by supporting an external USB connection for these devices to the USB port, which can be provisioned at console element 20, display 12, camera element 14, a proprietary device, or at any other suitable location.

The media sharing application (e.g., resident in console element 20) supports playback of compressed AV file media that is stored on the USB device. Furthermore, this media sharing can be supported via an external HDMI connection for these devices to the HDMI port. System 10 can also provide a mechanism for sharing digital photos and videos that are on a computer, on a Network Attached Storage (NAS) device, on the local network, etc. The mechanism can be universal plug and play (UPnP)/digital living network alliance (DLNA) renderer compliant. The media sharing application can also provide a mechanism for sharing digital photos and videos that are on either a photo or video sharing site (e.g., Flickr, YouTube, etc.), as discussed herein.

System 10 can also provide a mechanism for viewing broadcast HDTV programs (e.g., watching the Superbowl) with the HDTV set-top box HDMI AV feed displayed in picture-in-picture (PIP) with the call video. Continuing with this example, the Super Bowl broadcast feed can be from a local set-top box 32 and not be shared. Only the call video and voice would be shared in this example. The audio portion of the call can be redirected to handset 28 (e.g., speakerphone by default). The audio from the local TV can be passed through to HDMI and optical links (e.g., TOSlink outputs).

In an example scenario, initially the game video can fill the main screen and the call video could be in the smaller PIP. The audio for the game can pass through the box to the television, or to AV receiver surround-sound system. The audio for the video call would be supported by handset 28. In a different scenario, while watching the game, where one caller prefers to switch the main screen from the game to the video call (e.g., during halftime), then the following activities would occur. [Note that this is consistent with the other PIP experiences.] The call video can fill the main screen, where the game fills the smaller PIP window. The audio for the video call can move to the TV or to the AV receiver surround-sound system, and the game audio can switch to handset 28. Note that none of these activities requires the user to be “off camera” to control the experience: meaning, the user would not have to leave his couch in order to control/coordinate all of these activities.

In one particular example, console element 20 and camera element 14 can support any suitable frame rate (e.g., a 50-60 frames/second (fps) rate) for HD video for local, uncompressed inputs and outputs. Additionally, the video (e.g., the HDMI 1.3 video) can be provided as a digital signal input/output for local, uncompressed inputs and outputs. There is a passthrough for high-bandwidth Digital Content Protection (HDCP) data for local, uncompressed inputs and outputs from HDMI.

In regards to audio support, HDMI audio can be provided as a digital signal input/output. There can also be a stereo analog line-level output to support legacy devices in the environment. This is in addition to a digital audio output, which may be in the form of an optical link output such as a TOSlink output. For the audiovisual switching activities, audio and video can be patched from inputs, videoconferencing video, or other generated sources, to a local full-screen output. The architecture can offer a protocol for automatically turning on and selecting the correct source of the HDTV (along with any external audio system, when the audiovisual configuration allows for this while answering a call). This feature (and the other features of handset 28) can be implemented via infrared, Bluetooth, any form of the IEEE 802.11 protocol, HDMI-Consumer Electronics Control (CEC), etc.

In regards to camera element 14, the architecture can provide a full-motion video (e.g., at 30 fps). Participants outside of the range may be brought into focus via autofocus. Camera element 14 can provide identification information to console element 20, a set-top satellite, and/or any other suitable device regarding its capabilities. Camera element 14 can be provisioned with any suitable pixel resolution (e.g., 1280×720 pixel (720p) resolution, 1920×1080 pixel (1080p) resolution, etc.). If depth of focus is greater than or equal to two meters, then manual focus can be suggested for setup activities, and the autofocus feature/option would be desirable for the user. In operation, the user can manually focus camera element 14 on his sofa (or to any other target area) during setup. If successful, this issue would not have to be revisited. If depth of focus is less than or equal to one meter (which is commonly the case) then autofocus can be implemented. A digital people-action finder may also be provisioned for system 10 using camera element 14. Both pan and tilt features are available manually at setup, and during a video call. Similarly, zoom is available manually at set-up time, and during a video call.

Handset 28 may be equipped with any suitable microphone. In one particular implementation, the microphone is a mono-channel mouthpiece microphone optimized for capturing high quality audio in a voice range. The microphone may be placed to optimize audio capture with standard ear-mouth distance. Handset 28 can have a 3.5 mm jack for a headphone with microphone. Note that system 10 can support Home Network Administration Protocol (HNAP) and, further, be compatible with Network Magic, Linksys Easy-Link Advisor, or any other suitable home network management tool.

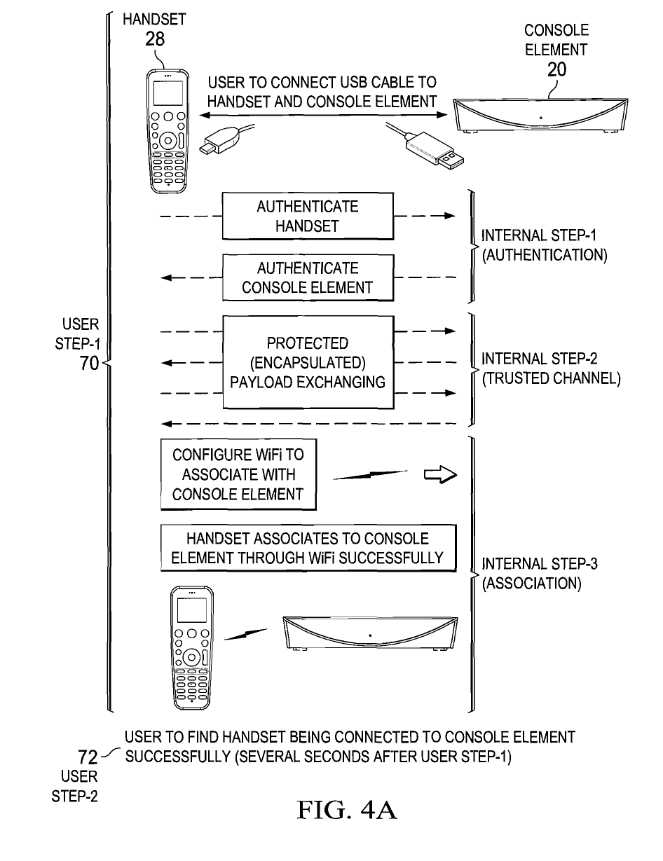

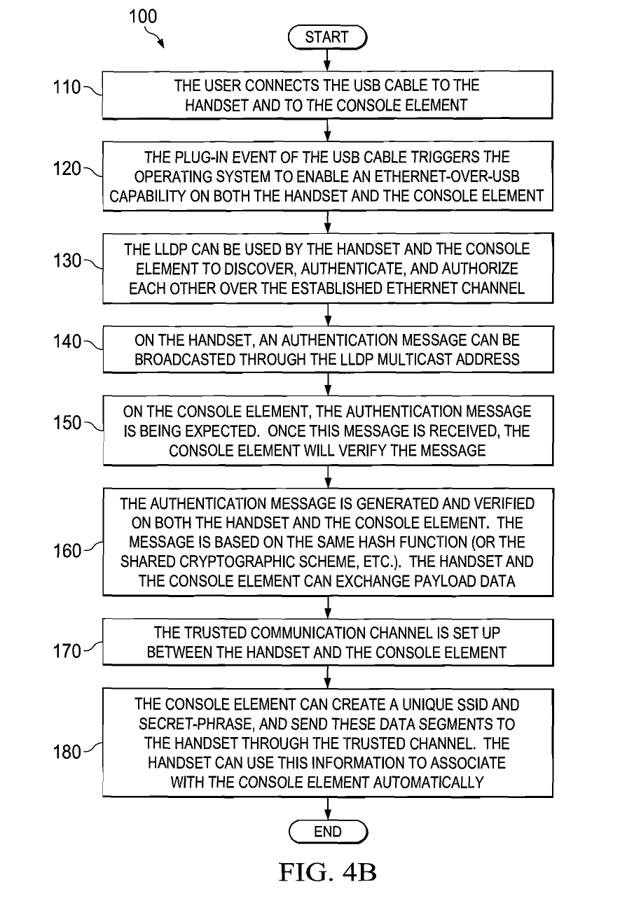

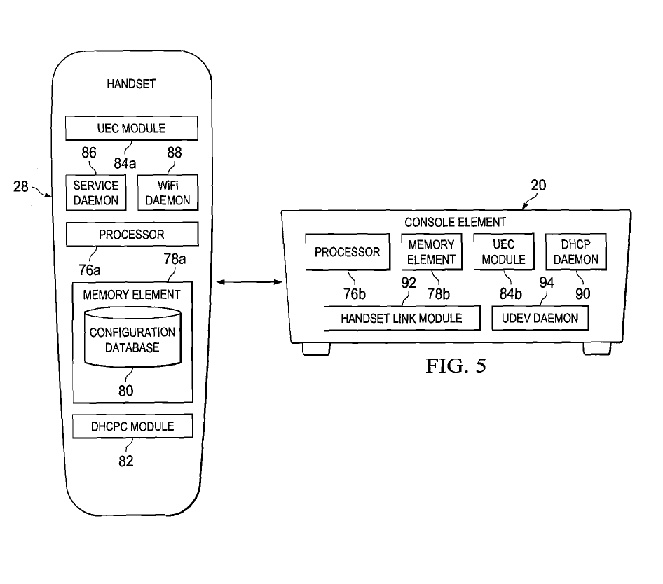

In one example, handset 28 has an infrared transmitter for controlling standard home theatre components. The minimum controls for handset 28 in this example can be power-on, input select, volume up/down, and audio output mute of the TV and AV receiver. Console element 20 (along with camera element 14) can have an infrared receiver to facilitate pairing of the videoconferencing system with other remote controls, which can allow other remotes to control the videoconferencing system. Suitable pairing can occur either by entering infrared codes into handset 28, or by pointing a remote from the target system at an infrared receiver of the videoconferencing system (e.g., similar to how universal remotes learn and are paired). Note that an enhanced pairing mechanism for handset 28 is described below with reference to FIGS. 4A-5.

For call management, system 10 can allow a user to initiate, accept, and disconnect calls to and from voice-only telephones (e.g., using handset 28 in a voice-only mode). Call forwarding can also be provided such that video calls are forwarded between console elements 20 at each endpoint of the video session. Additionally, announcements can be provided such that a default announcement video can be played to callers who are leaving a videomail. A self-view is available at any time, and the self-view can be triggered through a user demand by the user pressing a button on handset 28. The self-view can be supported with a mirror mode that shows the reverse image of the camera, as if the user was looking in a mirror. This can occur at any time, including while idle, while on a videoconferencing call, while on an audio-only call, etc.

FIG. 3 is a simplified block diagram illustrating one potential operation associated with system 10. In this particular implementation, console element 20 is provisioned with a VPN client module 44, and a media module 46. Console element 20 is coupled to a home router 48, which can provide connectivity to another videoconferencing endpoint 50 via a network 52. Home router 48 can also provide connectivity to a network that includes a number of video services 56. In this example, video services 56 include a consumer database 58, a videomail server 60 a call control server 62, a web services 64, and a session border controller 66.

Any number of traffic management features can be supported by system 10. In a simple example, system 10 can allow a point-to-point connection to be made between two home videoconferencing systems. A connection can also be made between a home videoconferencing system and an enterprise videoconferencing system. The packets associated with the call may be routed through a home router, which can direct the packets to an exchange or a gateway in the network. The consumer endpoint does not need to support the second data channel; any shared content can be merged into the main data stream. A multipoint connection can be made between a combination of three or more home and enterprise videoconferencing systems.

In operation, the VPN is leveraged in order to transmit administrative and signaling traffic to the network. Additionally, the media data [e.g., voice and video] can be exchanged outside of that link (e.g., it can be provisioned to flow over a high bandwidth point-to-point link). This linking can be configured to protect administrative and signaling traffic (which may be inclusive of downloads), while simultaneously conducting high-speed data communications over the point-to-point pathway.

Note that console element 20 and camera element 14 may share (or coordinate) certain processing operations. Using a similar rationale, their respective memory elements may store, maintain, and/or update data in any number of possible manners. In a general sense, the arrangements depicted in FIGS. 1-2 may be more logical in their representations, whereas a physical architecture may include various permutations/combinations/hybrids of these elements. In one example implementation, console element 20 and/or camera element 14 include software (e.g., as part of VPN client module 44 and media module 46) to achieve the data management operations, as outlined herein in this document. In other embodiments, these features may be provided externally to any of the aforementioned elements, or included in some other network element to achieve this intended functionality. Alternatively, several elements may include software (or reciprocating software) that can coordinate in order to achieve the operations, as outlined herein. In still other embodiments, any of the devices of the FIGURES may include any suitable algorithms, hardware, software, components, modules, interfaces, or objects that facilitate these switching operations.

In the particular example of FIG. 3, secure signaling and administrative data is depicted as propagating between home router 48 and video services 56. A number of VPN ports are also illustrated in FIG. 3. The ports can be associated with any appropriate security protocol (e.g., associated with IPsec, secure socket layer (SSL), etc.). Additionally, media data can propagate between network 52 and home router 48, where RTP ports are being provisioned for this particular exchange involving a counterparty endpoint 50. Semantically, multiple pathways can be used to carry the traffic associated with system 10. In contrast to other applications that bundle their traffic (i.e., provide a single hole into the firewall), certain implementations of system 10 can employ two different pathways in the firewall: two pathways for carrying two different types of data.

The objects within video services 56 are network elements that route or that switch (or that cooperate with each other in order to route or switch) traffic and/or packets in a network environment. As used herein in this Specification, the term ‘network element’ is meant to encompass servers, switches, routers, gateways, bridges, loadbalancers, firewalls, inline service nodes, proxies, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information.

Note that consumer database 58 may share (or coordinate) certain processing operations between any of the elements of video services 56. Using a similar rationale, their respective memory elements may store, maintain, and/or update data in any number of possible manners. In one example implementation, consumer database 58 includes software (e.g., as part of reverse lookup module 94 of FIG. 6) to achieve the data applications involving the user, as described herein. In other embodiments, these features may be provided externally to any of the aforementioned elements, or included in some other network element to achieve this intended functionality. Alternatively, several elements may include software (or reciprocating software) that can coordinate in order to achieve the operations, as outlined herein. In still other embodiments, any of the devices of the FIGURES may include any suitable algorithms, hardware, software, components, modules, interfaces, or objects that facilitate these switching operations.

In certain instances, video services 56 can be provisioned in a different location, or some other functionalities can be provided directly within the videoconferencing platform (e.g., within console element 20, camera element 14, display 12, etc.). This could be the case in scenarios in which console element 20 has been provisioned with increased intelligence to perform similar tasks, or to manage certain repositories of data for the benefit of the individual user.

FIG. 4A is a simplified flow diagram illustrating one potential interaction associated with system 10. The overview provided by FIG. 4A is associated with a method for pairing a wireless handset (e.g., handset 28) to a videoconferencing system. Handset 28 can be any type of control device (e.g., a remote control, a universal control, a mobile wireless unit, a smartphone, etc.) configured to control the behavior of display 12, camera element 14, etc. In a particular implementation, a USB cable plug-in event triggers the internal steps to complete the discovery, authentication, authorization, self-configuration, and the WiFi association procedures for a given handset 28. Further, this can be performed automatically without significant intervention from the end user.

Note that before detailing some of the operational aspects of FIG. 4A, it is important to understand operational aspects of common pairing mechanisms. The following foundational information is offered earnestly for purposes of teaching and example only and, therefore, should not be construed in any way to limit the broad teachings of the present disclosure. In many architectures, when a wireless mobile device (e.g., handset 28) is ready to associate with an access point (AP), it has to discover a service set identifier (SSID) (e.g., a name string) of an access point. Typically, the SSID is a name that relates to a particular 802.11 wireless LAN. A client device can receive broadcast messages from access points (i.e., within a range), where the access points systematically advertise their SSIDs. The client device can then either manually or automatically (based on configuration) select the network with which to associate. The SSID is commonly defined as a sequence of 1-32 octets: each of which may take any value. As a separate matter, handset 28 should also discover a corresponding secret phrase (e.g., a password) and, further, attempt an association with the target.

In videoconferencing scenarios, such approaches are deficient for number of reasons. First, the user experience is not ideal during the wireless association. For example, when each console element 20 serves as an access point, the unique SSID can be a long character string. Additionally, the Wi-Fi Protected Access (WPA and/or WPA2) based secret phrase can be complex, which makes it problematic to remember and to correctly enter. The WPA protocol is a certification program developed to indicate compliance with a security protocol for securing wireless computer networks. These long strings cause frustration for an end user, who has to input them into handset 28. As a general proposition, such a process would be tedious and, further, prone to errors.

Separately, when instantiations of console element 20 are widely deployed in crowded environments (e.g., an end user community, such as an apartment complex), a user may struggle to find the SSID of his own console element 20. In addition, there is an increased difficulty in authorizing certain approved devices. For example, console element 20 should be configured to only allow a trusted device to achieve a viable association. This would protect content from being hacked by malicious (unauthorized) WiFi devices.

Thus, in order to effectively associate with an access point, the user of a client device should discover the appropriate SSID of the access point, along with its secret phrase, and accurately type in the obtained information. If the SSID is not input precisely, the authentication would not be successful. To authorize a particular group of client devices before allowing them to access the access point, an architecture is typically required to have an authentication server (e.g., a RADIUS server) provisioned. IEEE 802.1x can offer the framework to achieve this kind of operation; however, such a configuration is complicated. Furthermore, such an approach would not efficiently solve the problem for a loosely-distributed consumer system.

In contrast to these activities, the solution being outlined by FIGS. 4A-5 involves minimizing the user's effort to obtain and to key-in the association information. Furthermore, the architecture can enable an appropriate self-discovery and self-configuration to automate the association/authentication process between Wi-Fi devices. This can be accomplished with minimal participation from the end user, who would be seeking to quickly setup his videoconferencing equipment.

To obviate the need for the end user to discover (i.e., and type in) the SSID and secret phrase of the endpoint, the architecture can leverage USBNET and IEEE 802.1AB Link Layer Discovery Protocol (LLDP) in a particular embodiment. These tools can enable handset 28 and console element 20 to identify and successfully authenticate each other. Note that the USBNET protocol allows for the creation of an IP network over the USB cable. In more general terms, the LLDP is a vendor-neutral Link Layer protocol in the Internet Protocol Suite used by network devices for advertising their identity, capabilities, and/or neighbors on a IEEE 802 local area network. More specifically, the protocol is referred to as the Station and Media Access Control Connectivity Discovery (specified in standards document IEEE 802.1AB).

In operational terms, a user of system 10 can utilize one USB cable to connect two devices through their USB ports. This allows the user to automatically associate these two devices within a few seconds (without additional intervention). At the same time, security requirements are not compromised, as these two devices can fully authenticate/authorize in a suitable fashion before the association occurs. Furthermore, the straightforward procedure allows for a mutual authentication and authorization between two independent WiFi devices. It should also be noted that this can occur without the need to configure an external authentication server.

Returning to the flow of FIG. 4A, a first user step 70 is depicted, where this involves the user connecting a USB cable to handset 28 (at one end) and to console element 20 (at the other end). Internally, the first step being illustrated is associated with an authentication for handset 28 being sent to console element 20. A second internal step is associated with a trusted channel, which involves exchanges between handset 28 and console element 20. Furthermore, these exchanges can involve encapsulated, payload exchanging, etc. A third internal step is related to associating handset 28 with console element 20. This can involve configuring the WiFi to associate with console element 20, where handset 28 successfully associates with console element 20 through the WiFi channel. A second user step 72 involves the user identifying that handset 28 is connected to console element 20. It should be noted that from first user step 70 to second user step 72, a matter of seconds have elapsed. Additionally, minimal user intervention was required to achieve this successful result. After a successful pairing, the user would see a suitable message on the display of handset 28 (e.g., ‘Congratulations, your handset is now ready to be used.’). At that point, the USB cable can be removed and the videoconferencing equipment can be fully utilized for its intended purposes.

Note that FIG. 4B further details some of the possible signaling associated with the pairing activities discussed herein. FIG. 4B is a simplified flowchart illustrating one example flow 100 associated with the present disclosure. For the pairing mechanism, there can be two general steps in accomplishing the procedure. First, the user connects the USB cable to handset 28 and to console element 20. This is illustrated by step 110. At step 120, the plug-in event of the USB cable triggers an operating system (OS) to enable an Ethernet-over-USB capability on both handset 28 and console element 20. The Ethernet-over-USB feature may provide Ethernet communications between handset 28 and console element 20 through the USB cable.

At step 130, the LLDP can be used by handset 28 and console element 20 to discover, authenticate, and authorize each other over the established Ethernet channel. More specifically, at step 140 and on handset 28, an authentication message can be broadcasted through the known LLDP (e.g., multicast) address. Step 150 reflects that console element 20 is expecting the authentication message. Once this message is received, console element 20 can verify the message. Note that only a matched message would be answered, whereas other messages (for which there is no match) can be ignored in certain embodiments. At step 160, the authentication message that is generated and verified (on both handset 28 and console element 20) is based on the same hash function, a shared cryptographic scheme, or any other appropriate security mechanism. After a mutual verification of the authentication message, handset 28 and console element 20 can exchange appropriate payload data. Note that in particular examples, these activities can be generally represented as follows:

| | |
|---|---|
| handset 28 ------- auth-msg --------> | console element 20 |
| handset 28 <------ auth-msg --------- | console element 20 |
| handset 28 ---- auth-msg + payload ----> | console element 20 |
| handset 28 <--- auth-msg + payload ----- | console element 20 |

At this juncture, the trusted communication channel is set up between handset 28 and console element 20. This is reflected by step 170. At step 180, console element 20 can create a unique SSID and a secret phrase (e.g., much like a WPA2-PSK), and then send these data segments to handset 28 through the trusted channel. Handset 28 can use this information to associate with console element 20 automatically. Note that the security keys (passwords, SSIDs) can be provided as a default, or they can be paired differently for each individual device(s). The password and the SSID can be any suitable alphanumeric string, digit string, character string, letter combination, or any suitable combination of these elements.

Note that in comparison to other approaches (e.g., the USB Method of Wi-Fi Protected Setup (WPS)), the proposed strategy of FIGS. 4A-4B authorizes the client device and the access point mutually. Also, the USB cable provisioning being proposed herein can provide real-time interactive transactions between the devices for authentication. It should also be noted that the proposed pairing strategy is more secure, as there is no trace being left on a USB memory stick, which may be vulnerable to subsequent hacking. Console element 20 is configured to only respond to a certified matched message in certain implementations (e.g., expecting a message from a particular handset, or a particular type of handset, or over a specific channel, or using a particular security mechanism, etc.), and this matching would provide an additional layer of security. Additionally, other methods for performing such pairing would unnecessarily involve extra steps to prompt the user to remove the USB stick, to plug the USB stick into the paired device, etc. Commonly, this process is repeated multiple times, where additional interactions are required of the user.

FIG. 5 is a simplified block diagram illustrating one possible implementation associated with handset 28 and console element 20. Any number of modules may be provided in these elements, where FIG. 5 is illustrating just one possible arrangement. It is imperative to note that these modules may be modified, removed, deleted, supplemented, or otherwise changed to accommodate different pairing scenarios, or to provide different relationships between these elements.

In this particular example, handset 28 and console element 20 include a respective universal emulation configurator (UEC) module 84a-b. UEC modules 84a-b can be associated with a USB Ethernet communication tool, which may exist between any given videoconferencing element and handset 28. Further, this particular module may also include the discovery and authentication features used to discover and to authenticate devices for the pairing process.

Handset 28 and console element 20 may also include a respective processor 76a-b and a respective memory element 78a-b. A configuration database 80 is included within memory element 78a of handset 28 in this example. Configuration database 80 may include proprietary code that offers a mini-database to store related configuration and authorization information. Handset 28 can also include a service daemon 86 and a WiFi daemon 88. Service daemon 86 may be configured to monitor the pairing procedure and the process of the WiFi association. WiFi daemon 88 may be configured to manage the WiFi association link (e.g., re-associate the link if it is dropped, etc.).

Handset 28 and console element 20 may include a Dynamic Host Configuration Protocol client (DHCPC) module 82 and a DHCP daemon 90, respectively. The DHCP elements may include a Linux OS code to assist in completing the WiFi association. In general terms, the DHCP allows a computer to be configured automatically, eliminating the need for intervention by a network administrator. Additionally, console element 20 may include a UDEV daemon 94, which may include Linux OS code in this example. UDEV daemon 94 can be configured to detect the USB plug-in/unplug events. Note that the UDEV can be configured to operate as the device manager for the Linux kernel series. In general terms, it can be configured to manage device nodes. Console element 20 may also include a handset link module 92, which can include proprietary code configured to execute the pairing process when a qualified device is detected.

In operation of a particular embodiment involving FIG. 5, the pairing process may begin with some type of USB insertion event. This can involve UEC module 84a of handset 28, along with UEC module 84b of console element 20. The initial interaction can include a device discovery and authentication operation. Once the devices are mutually authenticated, they can be authorized to exchange configuration information. In a particular instance, UEC modules 84a-b execute the majority of the pairing operation. UEC module 84b can operate in a passive mode, where UEC module 84a on handset 28 can operate in an active mode. Once the devices complete the configuration information exchange, service daemon 86 is configured to complete the WiFi association procedure. This can be assisted by WiFi daemon 88, DHCPC module 82 and DHCP daemon 90, and/or handset link module 92. Once the association is complete, any type of appropriate messaging can be rendered on the small user interface of handset 28.

Note that in certain example implementations, the pairing functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or any other similar machine, etc.). In some of these instances, a memory element [as shown in FIG. 5] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIG. 5] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

In one example implementation, handset 28 and/or console element 20 can include memory elements for storing information to be used in achieving the intelligent pairing operations, as outlined herein. Additionally, handset 28 and/or console element 20 may include a processor that can execute software or an algorithm to perform the pairing activities, as discussed in this Specification. All of these devices may further keep information in any suitable memory element (e.g., random access memory (RAM), ROM, EPROM, EEPROM, ASIC, etc.), software, hardware, or in any other suitable component, device, element, or object where appropriate and based on particular needs. Any of the memory items discussed herein (e.g., database, table, key, queue, etc.) should be construed as being encompassed within the broad term ‘memory element.’ Similarly, any of the potential processing elements, modules, and machines described in this Specification should be construed as being encompassed within the broad term ‘processor.’ Console element 20 and handset 28 can also include suitable interfaces for receiving, transmitting, and/or otherwise communicating data or information in a network environment.

Note that with the examples provided herein, interaction may be described in terms of two, three, or four elements. However, this has been done for purposes of clarity and example only. In certain cases, it may be easier to describe one or more of the functionalities of a given set of flows by only referencing a limited number of elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain server components, system 10 may be applicable to other protocols and arrangements (e.g., those involving any type of videoconferencing scenarios). Additionally, although camera element 14 has been described as being mounted in a particular fashion, camera element 14 could be mounted in any suitable manner in order to suitably capture video images. Other configurations could include suitable wall mountings, aisle mountings, furniture mountings, cabinet mountings, upright (standing) assemblies, etc., or arrangements in which cameras would be appropriately spaced or positioned to perform its functions.

Furthermore, the pairing mechanism described above can readily be used in conjunction with any other suitable endpoint device. In addition to handset 28, other wireless devices can be used in the pairing operations described above. For example, a smartphone of any kind can have an application that performs the activities described in FIGS. 4A-B. Additionally, the users described herein are simply individuals within the proximity, or within the field of view, of display 12. Audience members can be persons engaged in a video conference involving other individuals at a remote site. Audience members can be associated with corporate scenarios, consumer scenarios, residential scenarios, etc. or associated with any other suitable environment to which system 10 may be applicable.

Additionally, system 10 can involve different types of counterparties, where there can be asymmetry in the technologies being employed by the individuals. For example, one user may be using a laptop, while another user is using the architecture of system 10. Similarly, a smartphone could be used as one individual endpoint, while another user continues to use the architecture of system 10. Also, Webcams can readily be used in conjunction with system 10. Along similar lines, multiparty calls can readily be achieved using the teachings of the present disclosure. Moreover, although system 10 has been illustrated with reference to particular elements and operations that facilitate the communication process, these elements and operations may be replaced by any suitable architecture or process that achieves the intended functionality of system 10.

What is claimed is:

1. A method, comprising:
identifying an event associated with a universal serial bus (USB) connection;
establishing an Ethernet channel;
discovering a handset associated with a videoconferencing platform;
verifying an authentication message from the handset;
creating a service set identifier (SSID) and a password; and
communicating the SSID and the password to the handset through the Ethernet channel, wherein the SSID and the password are used to associate the handset with a console element configured to control operations associated with the videoconferencing platform.

2. The method of claim 1, wherein a link layer discovery protocol (LLDP) is used for discovering the handset associated with the videoconferencing platform.

3. The method of claim 1, wherein the event is associated with a USB cable being connected to the handset and the console element.

4. The method of claim 1, wherein the connection enables an Ethernet-over-USB capability on the handset and the console element.

5. The method of claim 1, wherein the authentication message is based on a security mechanism shared by the handset and the console element.

6. The method of claim 1, wherein the verifying includes identifying a match associated with the particular authentication message.

7. The method of claim 1, wherein a WiFi link is configured to be used for an association activity between the handset and the console element.

8. Logic encoded in one or more tangible media that includes code for execution and when executed by a processor operable to perform operations comprising:
identifying an event associated with a universal serial bus (USB) connection;
establishing an Ethernet channel;
discovering a handset associated with a videoconferencing platform;
verifying an authentication message from the handset;
creating a service set identifier (SSID) and a password; and
communicating the SSID and the password to the handset through the Ethernet channel, wherein the SSID and the password are used to associate the handset with a console element configured to control operations associated with the videoconferencing platform

9. The logic of claim 8, wherein a link layer discovery protocol (LLDP) is used for discovering the handset associated with the videoconferencing platform.

10. The logic of claim 8, wherein the event is associated with a USB cable being connected to the handset and the console element.

11. The logic of claim 8, wherein the connection enables an Ethernet-over-USB capability on the handset and the console element.

12. The logic of claim 8, wherein the authentication message is based on a security mechanism shared by the handset and the console element.

13. The logic of claim 8, wherein the verifying includes identifying a match associated with the particular authentication message.

14. An apparatus, comprising:
a memory element configured to store data;
a processor operable to execute instructions associated with the data; and
one or more modules, wherein the modules cooperate such that the apparatus is configured to:
identify an event associated with a universal serial bus (USB) connection;
establish an Ethernet channel;
discover a handset associated with a videoconferencing platform;
verify an authentication message from the handset;
create a service set identifier (SSID) and a password; and
communicate the SSID and the password to the handset through the Ethernet channel, wherein the SSID and the password are used to associate the handset with a console element configured to control operations associated with the videoconferencing platform.

15. The apparatus of claim 14, wherein a link layer discovery protocol (LLDP) is used for discovering the handset associated with the videoconferencing platform.

16. The apparatus of claim 14, wherein the event is associated with a USB cable being connected to the handset and the console element.

17. The apparatus of claim 14, wherein the connection enables an Ethernet-over-USB capability on the handset and the console element.

18. The apparatus of claim 14, wherein the authentication message is based on a security mechanism shared by the handset and the console element.

19. The apparatus of claim 14, further comprising:
a console element configured to interface with a display for rendering images associated with a video session involving the videoconferencing platform.

20. The apparatus of claim 14, wherein the verifying includes identifying a match associated with the particular authentication message.
